(19) United States
(12) Patent Application Publication
(10) Pub. No.: US 2023/0196228 A1
(43) Pub. Date: Jun. 22, 2023

(54) SYSTEM AND METHOD FOR PREDICTING TARGET-AGENTS FOR SHIFT-TRADE REQUEST BASED ON TRADING TRENDS OF AGENTS

(71) Applicant: NICE LTD., Ra'anana (IL)

(72) Inventors: Niranjan BAGADE, Pune (IN); Priyanka PADALALU, Pune (IN); Tanmay PATWARDHAN, Pune (IN)

(21) Appl. No.: 17/558,602

(22) Filed: Dec. 22, 2021

(51) Int. Cl. G06Q 10/06; G06Q 10/10

(52) U.S. Cl. CPC G06Q 10/063116; G06Q 10/109

(57) ABSTRACT

A computerized-method for predicting target-agents for a shift-trade request based on trading trends of agents, is provided herein. The computerized-method may include operating a trading-shifts module. The trading-shifts module may include (i) receiving a trade-request from a source-agent for a first-scheduled-shift; (ii) retrieving trading-data from the data store; (iii) operating an analysis of the trading-data according to a selection of the source-agent via the trading-shift-interface, to predict a probability of one or more target-agents to accept the first-scheduled-shift in exchange for a second-scheduled-shift; (iv) sorting the one or more predicted probability target-agents in a descending order, based on the predicted-probability; (v) sending a preconfigured-number of top predicted-probability target-agents to the computerized-device of the source-agent, to be presented, via the trading-shift-interface; and (vi) sending a notification with details of the first scheduled-shift for each computerized-device of the preconfigured-number of the top predicted-probability target-agents, to be presented via the trading-shift-interface thereof.

### TECHNICAL FIELD

The present disclosure relates to the field of data analysis for trading a scheduled-working-shift based on trading trends of agents.

### BACKGROUND

Agents in a contact center are scheduled on a particular shift, based on staffing requirements of the contact center. Occasionally, a scheduled contact center agent may not be available on a scheduled working shift due to various reasons. In current Workforce Management (WFM) systems there is a shift trade application, to allow agents to manage their unavailability during scheduled working shifts for a specific working day or shift, by manually selecting target-agents with whom they want to trade the scheduled shift. The selected target-agents are receiving a trade request which notifies them with details of the trade request.

Considering a contact center having 1,000 agents, when a source-agent may manually select target-agents for the scheduled shift trade from a list of agents, it may result with redundant trade requests to uninterested target-agents and missed opportunities to target-agents who could be interested in the shift trade. The problem may worsen in large contact centers with more than 30,000 agents, when thousands of agents are sending out thousands of trade requests throughout the day, all agents may be flooded with trading requests and sometimes for no reason.

In case none of the target-agents accept the shift trade request of the source-agent, the source-agent may take a day off during the scheduled-working-shift, e.g., due to personal reasons, which may result with the particular scheduled shift being understaffed.

Contact center staffing levels may also get affected due to an unavailability of agents, which may require a manual intervention by a supervisor for searching and reassigning the scheduled-working-shift to other available agents with the same set of skills as the unavailable agent.

When an agent tries to trade a shift with certain unknown agents, the main problem is which agents to approach, when manually selecting target agents. A source-agent must send the request to many target agents, which may or may not be interested in the offered shift. Also, target agents may receive unnecessary notifications.

When the shift-trade request is not accepted by any target-agent, commonly the shift-trade request gets expired after a certain period, e.g., 30 minutes. Then, the source-agent has to repeat the entire process and to wait for someone to accept the shift-trade request. Therefore, not only a source agent has to manually choose each and every target-agent, but the agent is also required to monitor if the trade request is accepted or not.

Accordingly, there is a need for a technical solution that will provide a source-agent, e.g., an agent that would like to trade a shift, a feature that will eliminate the manual process, such that the source-agent will no longer have to repeatedly raise the trade request. The needed feature has to suggest the chances that a target-agent would accept the shift trade request and to allow preferences of the source-agent or target-agents to be considered. Moreover, there is a need for a system and method for predicting target-agents for shift-trade based on trading trends of agents.

### SUMMARY

There is thus provided, in accordance with some embodiments of the present disclosure, a computerized-method for predicting a response to a shift-trade request based on trading trends of agents.

Furthermore, in accordance with some embodiments of the present disclosure, in a computerized system that includes one or more processors, and a memory including a data store of a plurality of agents with trading-shifts data stored thereon, the one or more processors may operate a trading-shifts module.

Furthermore, in accordance with some embodiments of the present disclosure, the trading-shifts module may include: (i) receiving a trade-request from a source-agent for a first scheduled-shift, via a trading-shift-interface associated with a computerized-device of the source-agent; (ii) retrieving trading-data from the data store during a preconfigured period; (iii) operating an analysis of the trading-data according to a selection of the source-agent via the trading-shift-interface, to predict a probability of one or more target-agents to accept the first scheduled-shift in exchange for a second scheduled-shift; (iv) sorting the one or more predicted probability target-agents in a descending order, based on the predicted probability; (v) sending a preconfigured number of top predicted probability target-agents to the computerized-device of the source-agent, to be presented, via the trading-shift-interface; and (vi) sending a notification with details of the first scheduled-shift for each computerized-device of the preconfigured number of the top predicted target-agents, to be presented via the trading-shift-interface thereof.

Furthermore, in accordance with some embodiments of the present disclosure, the trading-shifts module may further include enabling the source-agent, via the trading-shift-interface to select a recursive trade-request and upon a selection of a recursive trade-request, the trading-shifts module further comprising repeatedly sending a notification for a trade-request, with details of the first scheduled-shift for each computerized-device of the preconfigured number of next top predicted target-agents, to be presented via the trading-shift-interface thereof.

Furthermore, in accordance with some embodiments of the present disclosure, the notification for the trade-request may be sent repeatedly, a preconfigured number of times.

Furthermore, in accordance with some embodiments of the present disclosure, the trading-shifts module may further comprise enabling the source-agent to select a time-off request application for the first scheduled-shift, upon no response from the target-agents.

Furthermore, in accordance with some embodiments of the present disclosure, the received trade-request for a scheduled-shift may include: (i) date; and (ii) shift-type.

Furthermore, in accordance with some embodiments of the present disclosure, the selection of the source-agent may be one of: (i) source-agent preferences; or (ii) acceptance-probability of the target-agents.

Furthermore, in accordance with some embodiments of the present disclosure, when the selection is source-agent preferences, the retrieved trading data may include trade-request acceptances and trade-request rejections of the source-agent.

Furthermore, in accordance with some embodiments of the present disclosure, the trading-shifts module may further include determining a preferred day of the week and shift-type of the source-agent for the second scheduled-shift by calculating from the retrieved trading data (i) total trade-request acceptance and total trade-request rejections of the source-agent; (ii) total trade-request acceptances and total trade-request rejections per day of week of the source-agent; and (iii) shift-type acceptance per day of the week of the source-agent.

Furthermore, in accordance with some embodiments of the present disclosure, the trading-shifts module may further include retrieving target-agents with the highest number of trade requests with the source-agent in the past and target-agents with a scheduled shift as the determined preferred day of the week and shift-type, and then prioritizing target-agents which are having a trade request for the determined preferred day of the week and shift-type to be presented based on their priority to the source-agent, via the trading-shift-interface.

Furthermore, in accordance with some embodiments of the present disclosure, when the selection of the source-agent is acceptance-probability of the target-agents, the retrieved trading data may include one or more target-agents who do not have a scheduled-shift on the first scheduled-shift, and have the same skills as the source-agent. The trading-shifts module may further include calculating per each target-agent one or more parameters selected from: (i) total number of requests accepted from received requests; (ii) total number of requests accepted from received requests for a specific day for a specific shift-type; (iii) total number of requests accepted from received requests for a specific day; and (iv) total number of requests accepted from the received requests for a specific shift-type.

Furthermore, in accordance with some embodiments of the present disclosure, the trading-shifts module may further include assigning a preconfigured weight to each parameter of the one or more parameters to yield weighted parameters and calculating the predicted probability by summing the weighted parameters.

Furthermore, in accordance with some embodiments of the present disclosure, the sorting of the one or more predicted probability of target-agents in a descending order may include having the highest predicted-probability of target-agents as top predicted target-agents.

Furthermore, in accordance with some embodiments of the present disclosure, when the source-agent didn't select the time-off request application for the first scheduled-shift, upon no response from the target-agents, the trading-shifts module may send a notification of unsuccessful trade-request.

Furthermore, in accordance with some embodiments of the present disclosure, when the retrieved trading-data is less than a preconfigured number of records, the trading-shifts module may further include presenting via the trading-shift-interface of the computerized-device of the source-agent a message that there is not enough trading history to perform a trend analysis.

There is further provided a computerized-system for predicting target-agents for shift-trade request based on trading trends of agents.

Furthermore, in accordance with some embodiments of the present disclosure, the computerized-system may include one or more processors and a memory including a data store of a plurality of agents with trading-shifts data stored thereon. The one or more processors may operate a trading-shifts module as described above.

### BRIEF DESCRIPTION OF THE DRAWINGS

FIG. 1 schematically illustrates a prior art example of currently existing trading-shift-interface that is associated with a computerized-device of an agent;

FIG. 2 schematically illustrates a high-level diagram of a system for predicting target-agents for shift-trade based on trading trends of agents, in accordance with some embodiments of the present disclosure;

FIGS. 3A-3B are a high-level workflow of a trading-shifts module, in accordance with some embodiments of the present disclosure;

FIGS. 4A-4D schematically illustrate screenshots of a trade-request interface in different trade-request stages, in accordance with some embodiments of the present disclosure:

FIG. 5 schematically illustrates graphs of source-agent trade-requests analysis, in accordance with some embodiments of the present disclosure:

FIG. 6 illustrates graphs of target-agent trade-requests analysis of a target-agent presented in a list via a trade-request interface, in accordance with some embodiments of the present disclosure;

FIG. 7 illustrates a high-level workflow of a recursive trade-request option, in accordance with some embodiments of the present disclosure;

FIG. 8, a high-level workflow of retrieved trading data less than a preconfigured number, in accordance with some embodiments of the present disclosure;

FIG. 9 is a table of parameters and assigned preconfigured weight for each parameter, in accordance with some embodiments of the present disclosure; and

FIG. 10 is a table showing an example of calculation of predicted probability by summing weighted parameters of three target-agents when the selection of the source-agent is acceptance-probability of the target-agents, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

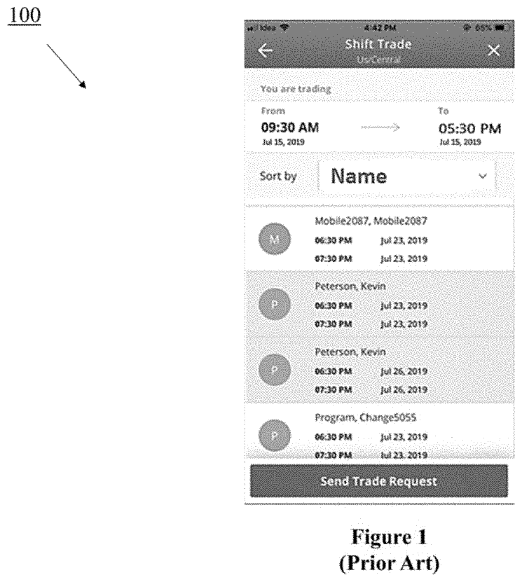

FIG. 1 schematically illustrates a prior art example of currently existing trading-shift-interface 100 that is associated with a computerized-device of an agent.

In current systems in contact centers, when an agent is not available to work on a scheduled-shift, the agent may try to trade the scheduled-shift with other agents, via a trading-shift-interface in a Workforce Management (WFM) system, such as trading-shift-interface 100. However, in current WFM solutions, a source-agent has to manually select target-agents with whom the source-agent wants to trade the scheduled-shift and the selected target-agents receive a trade request. The target-agents are merely sorted by name and not by the target-agents probability to accept the trade request.

The current solution has several deficiencies. One deficiency is that the source-agent doesn't know to which agent to approach with the trade-request and has to send the trade-request to many agents which may or may not be interested in the trade. As a result, many agents may receive many unnecessary trade notifications which they may not be interested in.

Another deficiency is that when none of the target-agents are willing to accept a trade request, it may result with the source-agent taking a day off during the scheduled-shift, which may leave the scheduled-shift understaffed. Yet another deficiency is that, contact center staffing levels may get affected due to an unavailability of agents, because they may be required to perform a manual intervention, e.g., a supervisor may search and assign the scheduled-shift to other available agents with the same set of skills as the unavailable agent. Yet another deficiency is that when the attempt of an agent to trade a scheduled-shift fails, it may reduce the flexibility of agents to work with the contact center and even hamper Employee Satisfaction (ESAT) score of the contact center.

Accordingly, there is a need for a technical solution that will take into consideration preferences of the source-agent and the target-agent and repeatedly send notifications to target-agents that have high probability to accept the trade-request.

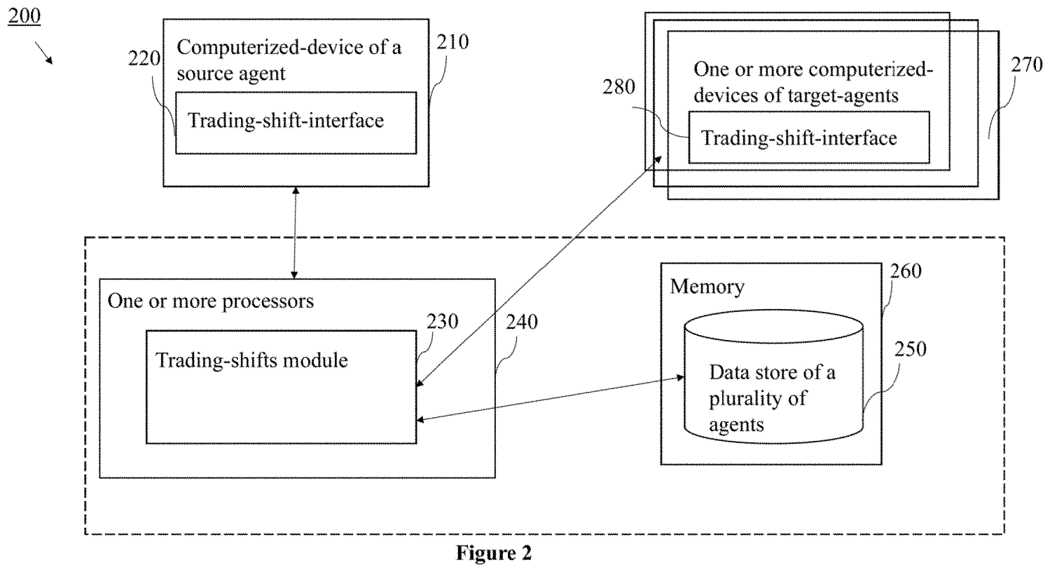

FIG. 2 schematically illustrates a high-level diagram of a system 200 for predicting target-agents for shift-trade based on trading trends of agents, in accordance with some embodiments of the present disclosure.

According to some embodiments of the present disclosure, a computerized-system, such as system 200 for predicting target-agents for shift-trade based on trading trends of agents, may include one or more processors 240, and a memory 260 including a data store of a plurality of agents 250 with trading-shifts data, stored thereon.

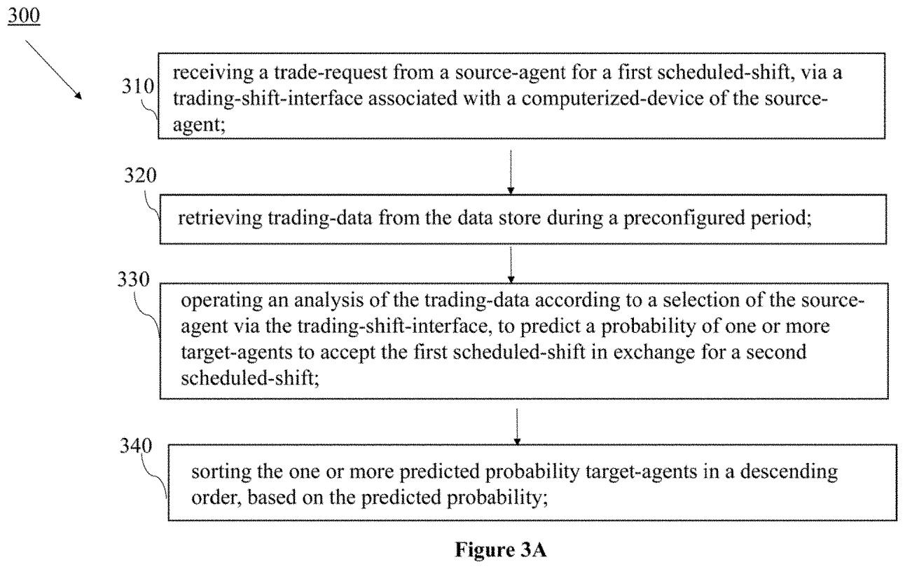

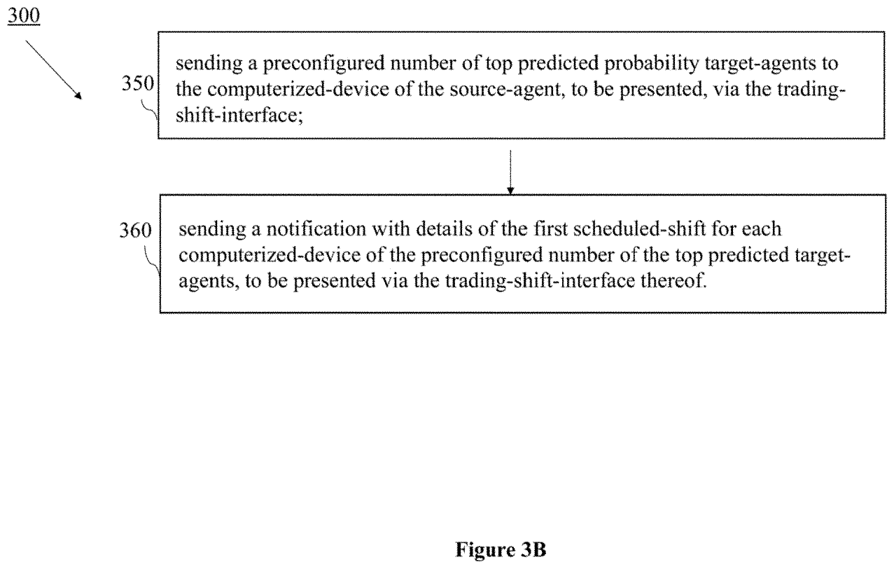

According to some embodiments of the present disclosure, the one or more processors 240 may operate a module, such as trading-shifts module 230 and such as trading-shifts module 300 in FIGS. 3A-3B.

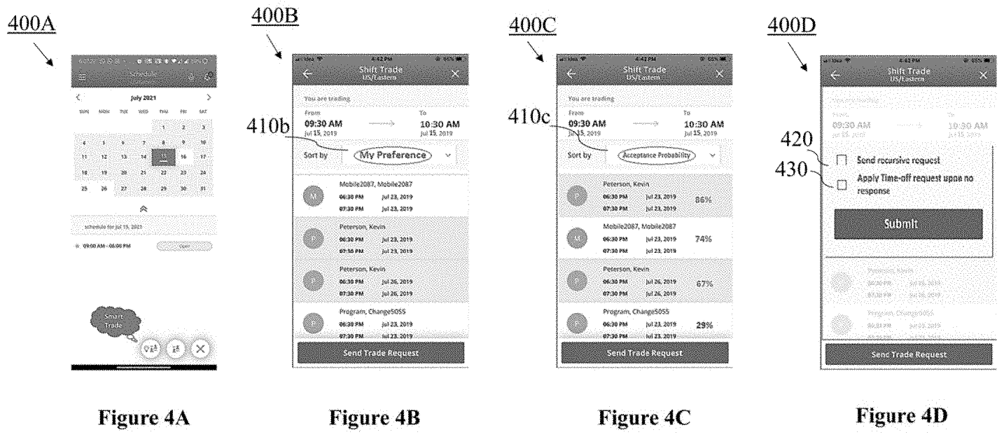

According to some embodiments of the present disclosure, the trading-shifts module 230 may receive a trade-request, from a source-agent for a first scheduled-shift, via a trading-shift-interface 220, such as trading-shift-interface screenshot 400A in FIG. 4A, that is associated with a computerized-device of the source-agent 210. The received trade-request for a scheduled-shift may include: (i) date; and (ii) shift-type.

According to some embodiments of the present disclosure, the trading-shifts module 230 may retrieve trading-data, during a preconfigured period, from the data store, such as data store of a plurality of agents 250. When the retrieved trading-data may be less than a preconfigured number of records, the trading-shifts module 230 may present via the trading-shift-interface 220 of the computerized-device of the source-agent 210 a message that there is not enough trading history to perform a trend analysis.

According to some embodiments of the present disclosure, the trading-shifts module 230 may operate an analysis of the trading-data according to a selection of the source-agent via the trading-shift-interface 220, to predict a probability of one or more target-agents to accept the first scheduled-shift in exchange for a second scheduled-shift. The selection may be for example an analysis based on the source-agent trading trends “My preferences”. In another example, the selection may be an analysis based on target-agents trading trends “acceptance probability”.

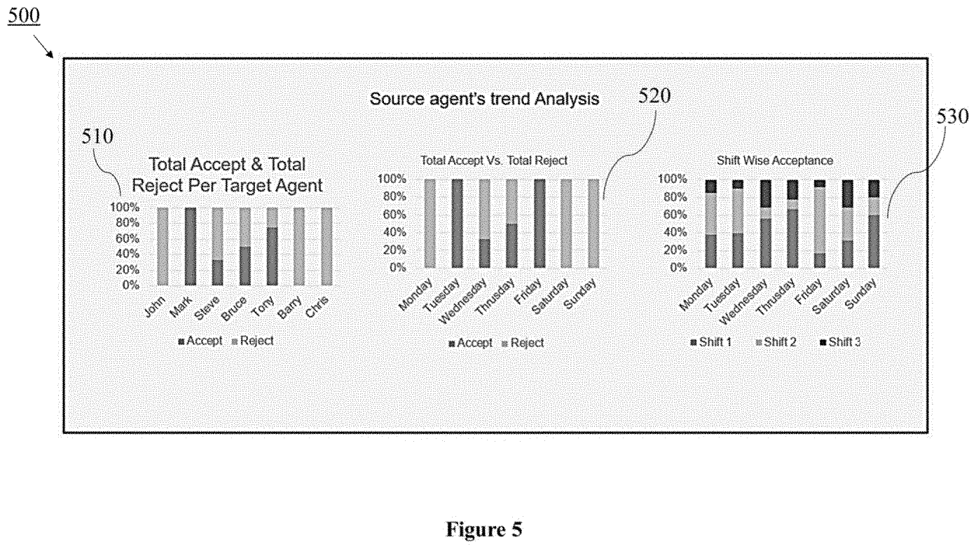

According to some embodiments of the present disclosure, the selection of the source-agent may be one of: (i) source-agent preferences; or (ii) acceptance-probability of the target-agents. When the selection is source-agent preferences, as shown in screenshot 400B in FIG. 4B, the retrieved trading data may include trade-request acceptances and trade-request rejections of the source-agent, as shown for example, in graphs of source-agent trade-requests analysis 500 in FIG. 5.

According to some embodiments of the present disclosure, the retrieved trading data may enable checking the history of trade actions of the source-agent and identifying a preferred day and time slot of shift in exchange to the first-scheduled-shift that the source-agent would like to trade.

According to some embodiments of the present disclosure, the trading-shifts module 230 may retrieve target-agents who traded the most with the source-agent in the past and then checking from those target-agents if they have a trade request for the identified preferred day and time slot, e.g., shift-type. Target-agents who requested to trade such shifts the identified preferred day and time slot may be prioritized. Then, those selected target-agents may be presented based on their priority to the source-agent, via the trading-shift-interface 220. The trading-shifts module 230 may also retrieve target-agents which have a scheduled shift on the identified preferred day and time slot, e.g., shift-type.

According to some embodiments of the present disclosure, when the selection of the source-agent is acceptance-probability of the target-agents, as shown in example 400C in FIG. 4C, the retrieved trading data may include one or more target-agents who do not have a scheduled-shift on the first scheduled-shift, and have the same skills as the source-agent.

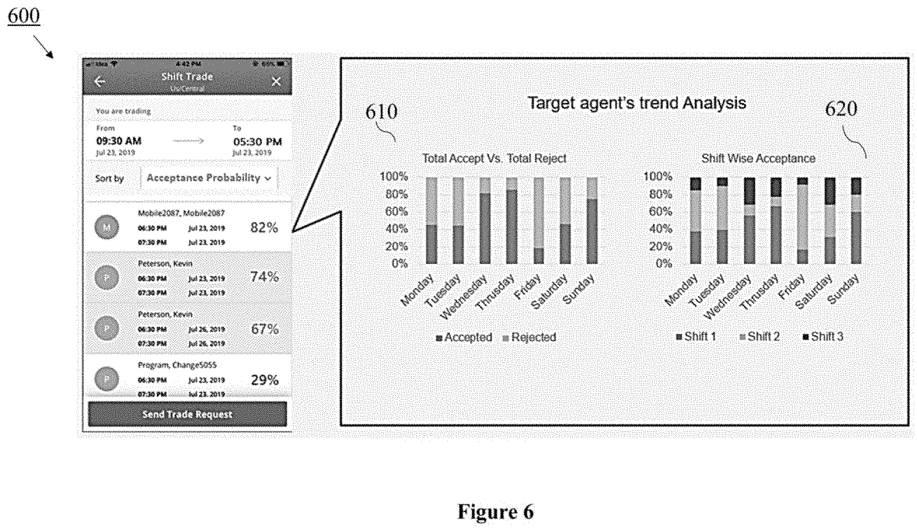

According to some embodiments of the present disclosure, the trading-shifts module 230 may calculate per each target-agent one or more parameters which may be selected for example from: (i) total number of requests accepted from received requests; (ii) total number of requests accepted from received requests for a specific day for a specific shift-type; (iii) total number of requests accepted from received requests for a specific day; and (iv) total number of requests accepted from the received requests for a specific shift-type, as shown for example, in graphs of target-agent trade-requests analysis of a target-agent 600 in FIG. 6, presented in a list via a trade-request interface.

According to some embodiments of the present disclosure, one or more preconfigured parameters may be considered. For example, as shown in table 1100 in FIG. 11, that is showing an example of calculation of predicted probability by summing weighted parameters of three target-agents, the parameters may be, number of requests that have been accepted from a total number of received requests for trade (p₁), total number of requests for trade that have been accepted from the received requests for a specific day for a specific shift-type (p₂), total number of requests for trade that have been accepted from the received requests for a specific day (p₃), and total number of requests for trade that have been accepted from the received requests for a specific shift (p₄).

According to some embodiments of the present disclosure, the trading-shifts module 230 may assign a preconfigured weight out of 100 depending on the parameters importance to the contact center, e.g., w, x, y, z to each parameter of the one or more parameters, e.g., p₁-p₄, to yield weighted parameters, e.g., w*p1, x*p2, y*p3, z*p4 and then calculate the predicted probability for each agent by summing the weighted parameters. For example, [w*p1+x*p2+y*p3+z*p4]×100, as shown in table 1100 in FIG. 11, for each agent, e.g., Agent A-Agent C.

According to some embodiments of the present disclosure, the one or more parameters may be configurable, as well as the preconfigured weight that may be assigned to each parameter.

According to some embodiments of the present disclosure, the trading-shifts module 230 may sort the one or more predicted probability of target-agents in a descending order, based on the calculated predicted probability. The sorting of the one or more predicted probability of target-agents in a descending order may include having the highest predicted-probability of each target-agent as top predicted target-agents.

According to some embodiments of the present disclosure, the trading-shifts module 230 may send a preconfigured number of top predicted probability target-agents to the computerized-device of the source-agent 210, to be presented, via the trading-shift-interface 220.

According to some embodiments of the present disclosure, the trading-shifts module 230 may further send a notification with details of the first scheduled-shift for each computerized-device of the preconfigured number of the top predicted target-agents, such as one or more computerized-devices of target-agents 270, to be presented via the trading-shift-interface 280 thereof.

According to some embodiments of the present disclosure, the trading-shifts module 230 may further enable the source-agent, via the trading-shift-interface 220 to select a recursive trade-request and upon a selection of a recursive trade-request, the trading-shifts module 230 may further repeatedly send a notification for a trade-request, with details of the first scheduled-shift for each computerized-device of the preconfigured number of next top predicted target-agents, to be presented via the trading-shift-interface thereof. The notification for the trade-request may be sent repeatedly a preconfigured number of times.

According to some embodiments of the present disclosure, the trading-shifts module 230 may further enable the source-agent to select a time-off request application for the first scheduled-shift, upon no acceptance from any of the target-agents that have revived a notification for a trade-request.

According to some embodiments of the present disclosure, when the source-agent didn't select the time-off request application for the first scheduled-shift, upon no response from the target-agents, the trading-shifts module 230 may send a notification of unsuccessful trade-request to the computerized-device of the source-agent 210 to be presented via the trading-shift-interface 220.

FIGS. 3A-3B are a high-level workflow of a trading-shifts module 300, in accordance with some embodiments of the present disclosure.

According to some embodiments of the present disclosure, operation 310 may comprise receiving a trade-request from a source-agent for a first scheduled-shift, via a trading-shift-interface associated with a computerized-device of the source-agent.

According to some embodiments of the present disclosure, operation 320 may comprise retrieving trading-data from the data store during a preconfigured period.

According to some embodiments of the present disclosure, operation 330 may comprise operating an analysis of the trading-data according to a selection of the source-agent via the trading-shift-interface, to predict a probability of one or more target-agents to accept the first scheduled-shift in exchange for a second scheduled-shift.

According to some embodiments of the present disclosure, operation 340 may comprise sorting the one or more predicted probability target-agents in a descending order, based on the predicted probability

According to some embodiments of the present disclosure, operation 350 may comprise sending a preconfigured number of top predicted probability target-agents to the computerized-device of the source-agent, to be presented, via the trading-shift-interface.

According to some embodiments of the present disclosure, operation 360 may comprise sending a notification with details of the first scheduled-shift for each computerized-device of the preconfigured number of the top predicted target-agents, to be presented via the trading-shift-interface thereof.

FIGS. 4A-4D schematically illustrate screenshots 400A-400D of a trade-request interface in different trade-request stages, in accordance with some embodiments of the present disclosure.

According to some embodiments of the present disclosure, by using a selection of one of the filters: (i) source-agent preferences; or (ii) acceptance-probability of the target-agents by the source-agent via a trading-shift-interface, such as trading-shift-interface 210 in FIG. 2, e.g., “My Preference” 410b in trading-shift-interface 400B or “Acceptance Probability” 410c in trading-shift-interface 400C. A system, such as system 200 may automatically send the trade request to a preconfigured number of target agents. A confirmation on automating the next activities may be displayed with the following options, as shown in trading-shift-interface 400D.

According to some embodiments of the present disclosure, trading-shift-interface 400D shows an option to send a recursive request 420. Upon a selection of this option, a trade request may be sent to a preconfigured number of target-agents having the highest predicted probability. e.g., top 5 predicted-probability of target-agents, as per the selected filter. Then, upon no response from the target-agents, the request will be extended to the next preconfigured number of target-agents, e.g., next 5 predicted probability of target-agents in the list of target-agents. The notification for the trade-request may be sent repeatedly to the target-agents, a preconfigured number of times.

According to some embodiments of the present disclosure, trading-shift-interface 400D shows an option to apply Time-off request upon no response 430. When the source-agent tic-marks this option, then in case none of the target-agents have accepted the trade request which has been sent repeatedly to the target-agents a preconfigured number of time, then a time off application, i.e., request for the first scheduled-shift may be applied for the source-agent.

According to some embodiments of the present disclosure, when the selection is source-agent preferences, e.g., “My preference” filter 410b, the retrieved trading data may include trade-requests history of the source-agent having trade-request acceptances and trade-request rejections of the source-agent.

According to some embodiments of the present disclosure, a module, such as trading-shifts module 230 in FIG. 2, may operate a trend analysis to determine a preferred day of the week and shift-type of the source-agent for the second scheduled-shift, by calculating from the retrieved trading data (i) total trade-request acceptance and total trade-request rejections of the source-agent; (ii) total trade-request acceptances and total trade-request rejections per day of week of the source-agent; and (iii) shift-type acceptance per day of the week of the source-agent.

According to some embodiments of the present disclosure, a shift-type may be for example morning shift from 08:00 am to 04:00 pm or afternoon shift from 04:00 to 00:00 am or night shift from 00:00 am to 08:00 am.

According to some embodiments of the present disclosure, a module, such as trading-shifts module 230 in FIG. 2, may predict a probability of one or more target-agents to accept the first scheduled-shift in exchange for the second scheduled-shift, based on the determined preferred day of the week and shift-type, by using the retrieved trading data to find a preferred shift-type in a preferred day of the source-agent for the second scheduled-shift and retrieving from the data store, such as data store of a plurality of agents target-agents 250 in FIG. 2, target-agents with a trade-request for the second scheduled-shift. For example, the highest predicted-probability may be assigned to a target-agent that has interacted with the source-agent in the past and an afternoon-shift on Tuesdays or Fridays are the preferences of the source-agent or to a target-agent that is scheduled a shift as the determined preferred day of the week and shift-type.

For example, in a scenario, where there is a source-agent ‘S’ and target-agents ‘T₁’, ‘T₂’ and ‘T₃’. Source-agent ‘S’ and ‘T₁’ have traded multiple shifts in the past, so ‘T₁’ would be one of the top predicted probabilities. Source-agent ‘S’ and agent ‘T₂’ have never traded a shift in the past, however, based on source-agent S's trend analysis, it may be found that source-agent ‘S’ prefers afternoon shifts on Tuesdays and Fridays, and suppose source-agent ‘T₂’ has a scheduled afternoon shift on Tuesday or Friday which the agent may offer in return to agent ‘S’, then target-agent ‘T₂’ would also be one of the top predicted probabilities. On the other hand, target-agent ‘T₁’ has never interacted with source-agent ‘S’, nor does target-agent ‘T₃’ have any shift of interest for source-agent ‘S’, then target-agent ‘T₃’ would have the lowest predicted probability.

According to some embodiments of the present disclosure, when the selection of the source-agent is acceptance-probability of the target-agents, e.g., Acceptance Probability” 410c, the retrieved trading data may include one or more target-agents who do not have a scheduled-shift on the first scheduled-shift, and have the same skills as the source-agent.

According to some embodiments of the present disclosure, a module, such as trading-shifts module 230 in FIG. 2, may calculate per each target-agent one or more parameters selected from: (i) total number of requests accepted from received requests; (ii) total number of requests accepted from received requests for a specific day for a specific shift-type; (iii) total number of requests accepted from received requests for a specific day; and (iv) total number of requests accepted from the received requests for a specific shift-type, as detailed above.

FIG. 5 schematically illustrates graphs of source-agent trade-requests analysis 500, in accordance with some embodiments of the present disclosure.

According to some embodiments of the present disclosure, a module, such as trading-shifts module 230 in FIG. 2, may operate a trend analysis to determine a preferred day of the week and shift-type of the source-agent for the second scheduled-shift, by calculating from the retrieved trading data (i) total trade-request acceptance and total trade-request rejections of the source-agent; (ii) total trade-request acceptances and total trade-request rejections per day of week of the source-agent; and (iii) shift-type acceptance per day of the week of the source-agent

For example, in a scenario where a source-agent ‘S’, target-agents ‘T₁’, ‘T₂’ and ‘T₃’. Graph 510 shows a ratio of trade requests which have been accepted by source-agent ‘S’ and which were sent by the agents ‘T₁’, ‘T₂’ and ‘T₁’ in the past regardless of the day and shift-type of that trade-request. Graph 520 shows the ratio of total requests accepted vs rejected by source-agent ‘S’ for each day of the week in the past which may have been sent by target-agents ‘T₁’, ‘T₂’ or ‘T₃’, or any other agent. Graph 530 shows the ratio of total requests accepted across each shift-type. For example, the column of Monday in graph 530 shows that source-agent ‘S’ accepted 40% shift-1 requests, around 45% shift-2 requests, and remaining 15% for shift-3 requests.

FIG. 6 illustrates graphs of target-agent trade-requests analysis of a target-agent 600 that is presented in a list via a trade-request interface, in accordance with some embodiments of the present disclosure.

According to some embodiments of the present disclosure, when the selection of the source-agent is acceptance-probability of the target-agents, e.g., “Acceptance Probability” 410c in FIG. 400C, the retrieved trading data may include one or more target-agents who do not have a scheduled-shift on the first scheduled-shift, and have the same skills as the source-agent.

According to some embodiments of the present disclosure, a module, such as trading-shifts module 230 in FIG. 2 may calculate per each target-agent one or more parameters selected from: (i) total number of requests accepted from received requests; (ii) total number of requests accepted from received requests for a specific day and for a specific shift-type. The parameters are presented by graphs of target-agent trade-requests analysis of a target-agent 600.

According to some embodiments of the present disclosure, graph 610 shows the overall trade-requests that have been accepted by a target-agent vs the overall trade-requests that have been rejected by a target-agent. Graph 610 represents a consideration of historic trends for a particular target-agent and provides an insight about the behavioral trend of each and every eligible target-agent.

According to some embodiments of the present disclosure, graph 620 shows a drill down to represent the shill-type details on each day of the week, for each of the eligible target-agents. For example, target-agent ‘Mobile2087’ has accepted 80% of the total trade-requests received for a shift that has been scheduled on Wednesday, as shown in graph 610. Also, target-agent ‘Mobile2087’ has accepted 50% requests from shift-1, 10% of shift-2 and 40% of shift-3 approximately, out of the total accepted requests, as shown in graph 620.

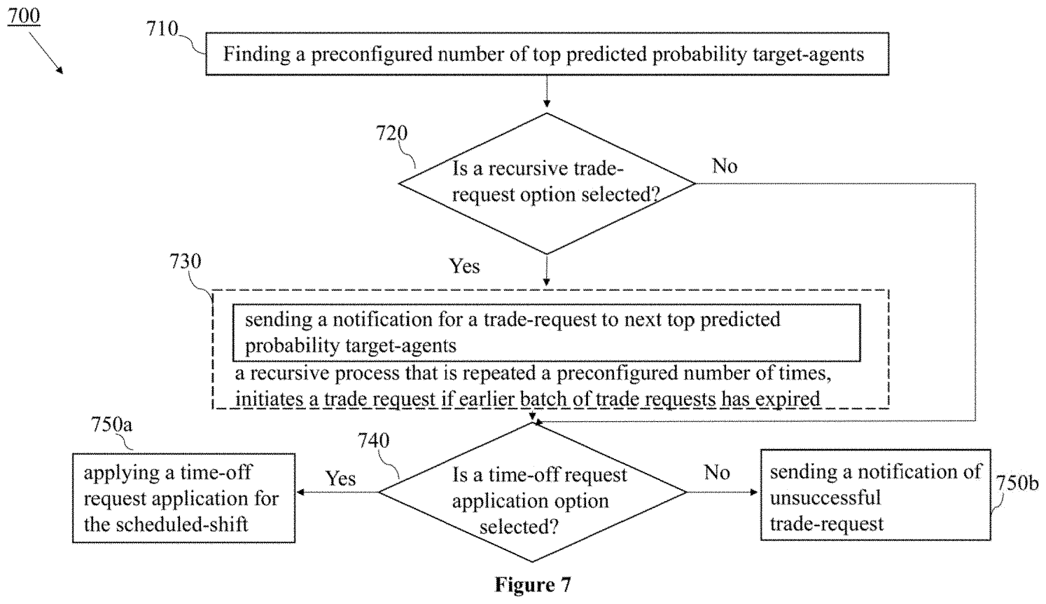

FIG. 7 illustrates a high-level a high-level workflow of a recursive trade-request option 700, in accordance with some embodiments of the present disclosure.

According to some embodiments of the present disclosure, operation 710 comprising finding a preconfigured number of top predicted probability target-agents.

According to some embodiments of the present disclosure, after a preconfigured number of top predicted probability target-agents has been found, checking if a recursive trade-request option is selected 720.

According to some embodiments of the present disclosure, when a recursive trade-request option has been selected, sending a notification for a trade-request to next top predicted probability target-agents. A recursive process may be repeated a preconfigured number of times, which may initiate a trade request if earlier batch of trade requests has expired 730.

According to some embodiments of the present disclosure, after a preconfigured number of times checking is a time-off request application option has been selected 740.

According to some embodiments of the present disclosure, if a time-off request application option has been selected, applying a time-off request application for the scheduled-shift 750a.

According to some embodiments of the present disclosure, if a time-off request application option has not been selected, sending a notification of unsuccessful trade-request 750b.

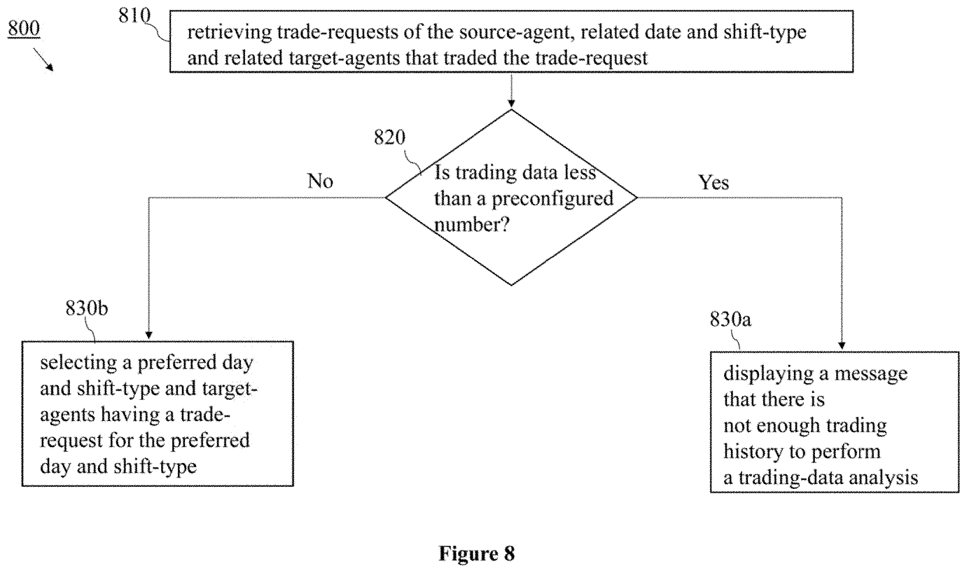

FIG. 8, a high-level workflow 800 of retrieved trading data less than a preconfigured number, in accordance with some embodiments of the present disclosure.

According to some embodiments of the present disclosure, when retrieving trade-requests of the source-agent, related date and shift-type and related target-agents that traded the trade-request 810, checking is trade data less than a preconfigured number 820.

According to some embodiments of the present disclosure, when the trading data is less

than a preconfigured number, displaying a message that there is not enough trading history to perform a trading-data analysis 830a.

According to some embodiments of the present disclosure, when the trading data is more than a preconfigured number, selecting a preferred day and shift-type and target-agents having a trade-request for the preferred day and shift-type 830b.

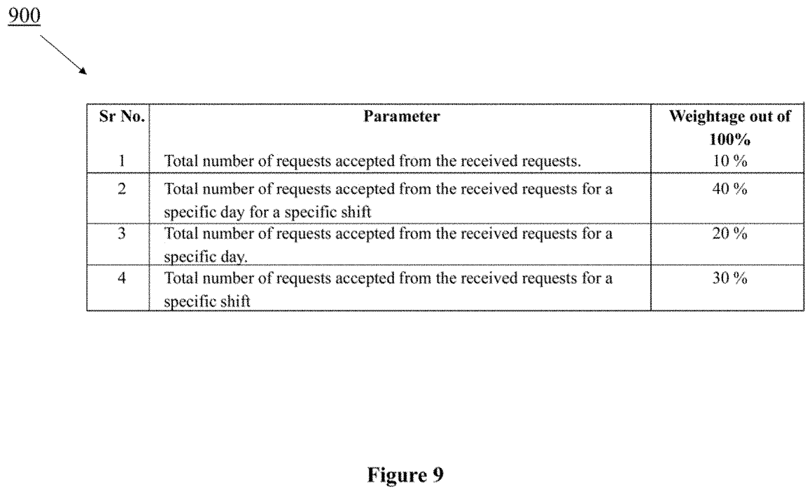

FIG. 9 is a table 900 of parameters and assigned preconfigured weight for each parameter, in accordance with some embodiments of the present disclosure.

According to some embodiments of the present disclosure, a module, such as trading-shifts module 230 in FIG. 2, may calculate per each target-agent one or more parameters. The one or more parameters may be selected for example from: (i) total number of requests accepted from received requests; (ii) total number of requests accepted from received requests for a specific day for a specific shift-type; (iii) total number of requests accepted from received requests for a specific day; and (iv) total number of requests accepted from the received requests for a specific shift-type.

According to some embodiments of the present disclosure, each parameter from the one or more parameters may be assigned a preconfigured weight to yield weighted parameters.

The total number of requests accepted from the received requests has been assign a weight of 10%, the total number of requests accepted from the received requests for a specific day for a specific shift has been assign a weight of 40%, the total number of requests accepted from the received requests for a specific day has been assign a weight of 20%, and the total number of requests accepted from the received requests for a specific shift has been assign a weight of 30%. The predicted probability may be calculated by summing the weighted parameters as shown in FIG. 11.

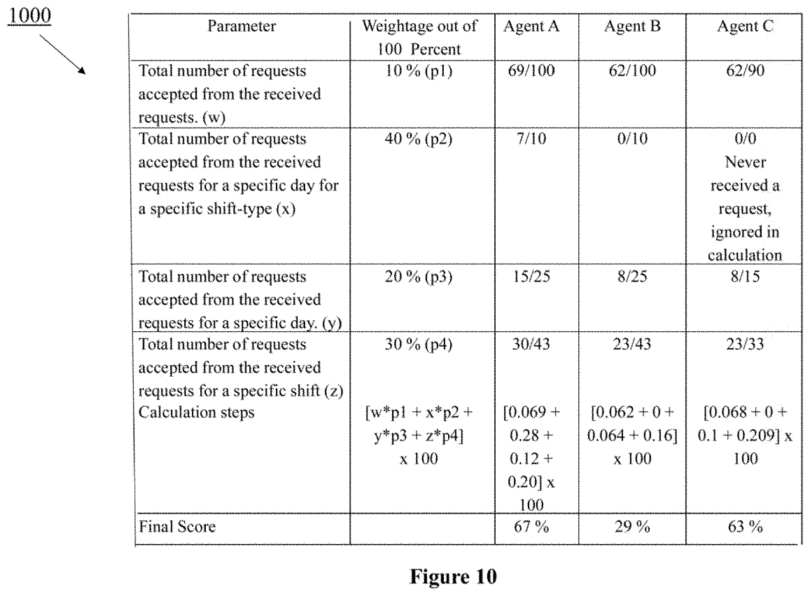

FIG. 10 is a table 1000 showing an example of calculation of predicted probability by summing weighted parameters of three target-agents when the selection of the source-agent is acceptance-probability of the target-agents, in accordance with some embodiments of the present disclosure.

According to some embodiments of the present disclosure, based on the weights assigned to the parameters, as shown in table 1000 FIG. 10, when for example, an agent wants to trade a morning shift of coming Monday and there could be more than 100 target-agents with whom the agent could potentially trade this shift, e.g. target-agents who do not have a scheduled-shift on the first scheduled-shift, and have the same skills as the source-agent. Target agents having the predicted-probability may be presented first to the source-agent.

According to some embodiments of the present disclosure, as shown in table 1000 agent A has received some requests for Monday during morning shift, he accepted 7 out of 10 of these requests. Agent B has received some requests for morning shift of coming Monday, but she did not accept any of these requests. Agent C didn't receive any requests for morning shift of coming Monday at all and may be ignored in calculation of total number of requests accepted from the received requests for a specific day for a specific shift-type. This parameter has been assigned a weight of 40%.

According to some embodiments of the present disclosure, each parameter has been assigned a weight and the weighted parameters may be used to calculate the predicted probability by summing the weighted parameters. Accordingly, the total score, e.g., predicted probability of agent A is 67%, of agent B is 29% and of agent C is 63%.

According to some embodiments of the present disclosure, agent A and agent C will be presented at the top of the list of target-agents for the source-agent via the trading-shift-interface associated to the computerized-device of the source-agent.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for predicting target-agents for a shift-trade request based on trading trends of agents, the computerized-method comprising:
in a computerized-system comprising one or more processors, and a memory including a data store of a plurality of agents with trading-shifts data stored thereon, said one or more processors are operating a trading-shifts module, said trading-shifts module comprising:
receiving a trade-request from a source-agent for a first scheduled-shift, via a trading-shift-interface associated with a computerized-device of the source-agent;
retrieving trading-data from the data store during a preconfigured period;
operating an analysis of the trading-data according to a selection of the source-agent via the trading-shift-interface, to predict a probability of one or more target-agents to accept the first scheduled-shift in exchange for a second scheduled-shift;
sorting the one or more predicted probability target-agents in a descending order, based on the predicted probability;
sending a preconfigured number of top predicted probability target-agents to the computerized-device of the source-agent, to be presented, via the trading-shift-interface; and
sending a notification with details of the first scheduled-shift for each computerized-device of the preconfigured number of the top predicted-probability target-agents, to be presented via the trading-shift-interface thereof.

2. The computerized-method of claim 1, wherein the trading-shifts module is further comprising enabling the source-agent, via the trading-shift-interface to select a recursive trade-request and wherein upon a selection of a recursive trade-request the trading-shifts module further comprising repeatedly sending a notification for a trade-request, with details of the first scheduled-shift for each computerized-device of the preconfigured number of next top predicted target-agents, to be presented via the trading-shift-interface thereof.

3. The computerized-method of claim 2, wherein the notification for the trade-request is sent repeatedly a preconfigured number of times.

4. The computerized-method of claim 2, wherein the trading-shifts module is further comprising enabling the source-agent to select a time-off request application for the first scheduled-shift, upon no response from the target-agents.

5. The computerized-method of claim 1, wherein the received trade-request for a scheduled-shift includes: (i) date; and (ii) shift-type.

6. The computerized-method of claim 1, wherein the selection of the source-agent is one of: (i) source-agent preferences; or (ii) acceptance-probability of the target-agents.

7. The computerized-method of claim 6, wherein when the selection is source-agent preferences, the retrieved trading data includes trade-request acceptances and trade-request rejections of the source-agent.

8. The computerized-method of claim 7, wherein the trading-shifts module is further comprising determining a preferred day of the week and shift-type of the source-agent for the second scheduled-shift by calculating from the retrieved trading data (i) total trade-request acceptance and total trade-request rejections of the source-agent; (ii) total trade-request acceptances and total trade-request rejections per day of week of the source-agent; and (iii) shift-type acceptance per day of the week of the source-agent.

9. The computerized-method of claim 8, wherein the trading-shifts module is further comprising retrieving target-agents with a highest number of trade requests with the source-agent in the past and target-agents with a scheduled shift as the determined preferred day of the week and shift-type, and then prioritizing target-agents which are having a trade request for the determined preferred day of the week and shift-type to be presented based on their priority to the source-agent, via the trading-shift-interface.

10. The computerized-method of claim 6, wherein when the selection of the source-agent is acceptance-probability of the target-agents, the retrieved trading data includes one or more target-agents who do not have a scheduled-shift on the first scheduled-shift, and have the same skills as the source-agent and wherein the trading-shifts module is further comprising calculating per each target-agent one or more parameters selected from: (i) total number of requests accepted from received requests; (ii) total number of requests accepted from received requests for a specific day for a specific shift-type; (iii) total number of requests accepted from received requests for a specific day; and (iv) total number of requests accepted from the received requests for a specific shift-type.

11. The computerized-method of claim 10, wherein the trading-shifts module is further comprising assigning a preconfigured weight to each parameter of the one or more parameters to yield weighted parameters and calculating the predicted probability by summing the weighted parameters.

12. The computerized-method of claim 11, wherein the sorting of the one or more predicted probability of target-agents in a descending order is having the highest predicted-probability of each target-agent as top predicted target-agents.

13. The computerized-method of claim 4, wherein when the source-agent didn't select the time-off request application for the first scheduled-shift, upon no response from the target-agents, sending a notification of unsuccessful trade-request.

14. The computerized-method of claim 1, when the retrieved trading-data is less than a preconfigured number of records, the trading-shifts module is further comprising presenting via the trading-shift-interface of the computerized-device of the source-agent a message that there is not enough trading history to perform a trend analysis.

15. A computerized-system for predicting target-agents for a shift-trade request based on trading trends of agents, the computerized-system comprising:
one or more processors;
and a memory including a data store of a plurality of agents with trading-shifts data stored thereon,
said one or more processors are operating a trading-shifts module, said trading-shifts module comprising:
receiving a trade-request from a source-agent for a first scheduled-shift, via a trading-shift-interface associated with a computerized-device of the source-agent;
retrieving trading-data from the data store during a preconfigured period;
operating an analysis of the trading-data according to a selection of the source-agent via the trading-shift-interface, to predict a probability of one or more target-agents to accept the first scheduled-shift in exchange for a second scheduled-shift;
sorting the one or more predicted probability target-agents in a descending order, based on the predicted probability;
sending a preconfigured number of top predicted probability target-agents to the computerized-device of the source-agent, to be presented, via the trading-shift-interface; and
sending a notification with details of the first scheduled-shift for each computerized-device of the preconfigured number of the top predicted-probability target-agents, to be presented via the trading-shift-interface thereof.
